(19) United States
(12) Patent Application Publication
(10) Pub. No.: US 2026/0132864 A1
(43) Pub. Date: May 14, 2026

(54) DRILL STEM SAFETY VALVE ACTUATOR

(71) Applicant: Hi-Kalibre Equipment Limited, Edmonton (CA)

(72) Inventors: Tony Charles Leon Standbridge, Sherwood Park (CA); Aaron Ben Ephraim, Edmonton (CA); Hamidreza Ahmadi Moghaddam, Edmonton (CA); Tod Michael Hohl, Sherwood Park (CA); Patrick Kenneth Rabby, Sherwood Park (CA); Steven William Zilkie, Leduc County (CA)

(73) Assignee: Hi-Kalibre Equipment Limited, Edmonton, AB (CA)

(21) Appl. No.: 19/383,644

(22) Filed: Nov. 8, 2025

Related U.S. Application Data
(60) Provisional application No. 63/718,478, filed on Nov. 8, 2024.

(51) Int. Cl. F16K 31/54; E21B 34/02; F16K 5/06

(52) U.S. Cl. CPC F16K 31/54; E21B 34/02; F16K 5/0647; E21B 2200/04

(57) ABSTRACT

A drill stem safety valve actuator that eliminates the need for a hydraulic union is described in the disclosure. The actuator can include a mounting sleeve that can be affixed to the valve, that can further have a pinion gear that can rotate a ball valve. The actuator can include a rack sleeve slidably disposed on the mounting sleeve, having a rack configured to engage the pinion wherein sliding the rack sleeve linearly along the length of the mounting sleeve rotates the pinion, thus, the ball valve.

### CROSS-REFERENCE TO RELATED APPLICATIONS

This application claims priority of U.S. provisional patent Application Ser. No. 63/718,478 entitled “Drill Steam Safety Valve Actuator” and filed Nov. 8, 2024 in the names of Tony Charles Leon Standbridge et al., which is incorporated by reference into this application in its entirety.

### TECHNICAL FIELD

The present disclosure is related to the field of valve actuators, in particular, actuators for drill stem safety valves.

### BACKGROUND

Drill stem safety valves (“DSSV”) typically have two primary purposes: a) they are a safety device that can be closed to prevent mud and/or well fluid from flowing back up the interior of the drill pipe in the event of an unbalanced pressure in the mud column; and b) they can be used as a flow control device to turn on and off the flow of mud while making and breaking connections during drilling operations for top drives. When used for blow out prevention, these valves are only used during testing or in emergencies. However, in mud control, they can be operated several hundred times in the drilling of a single well.

To operate a DSSV, the stem is turned ninety degrees from open to closed position and back again, by applying torque to the DSSV stem. This torque can be applied manually, or by remote actuator. For mud saving operations, remote actuation is the preferred method of applying torque to the DSSV. Remote actuators generally deliver the torque to the stem of a valve through a hexagonal or square shaft that interfaces with the matching internal profile of the stem.

When the valve is used for blowout prevention, the valve can be subjected to high internal pressure which causes a significant amount of compressive load on the valve ball as it moves from open to close. This high load necessitates the application of high torque to the valve stem in order to ensure that the ball completely closes and fully stops the unwanted flow reversal. Some valves require upwards of 2000 ft-lbs to operate while under pressure. A remote actuator is the most efficient method for delivering the high torque required.

Actuators generally supply a fixed amount of torque, i.e. the maximum output of the actuator. The high torque delivered to valve stem can damage the internal stops for the valve stems. This damage generally leads to over travel of the ball in the open, close, or both positions. This over travel can be detrimental to the life of the valve and the safety that it is supposed to provide. For example, when the ball over travels in the open position, the flow of mud is directed off the longitudinal axis of the valve leading to accelerated wash of the valve's internal components. When the ball over travels in the close position, the valve ball may rotate to the extent that it no longer completely blocks the flow of mud, or in the case of blowout prevention: reservoir fluids.

Remote actuators currently use pneumatics and/or hydraulics to create the motive force that applies torque to the actuator/DSSV interface. In most cases, a linear motion is translated to a rotational motion through the use of racks and pinions or linkages.

In order to be able to deliver the torque to the DSSV stem, the actuator must be attached to the DSSV thus rotating when the DSSV is rotating. Therefore, delivery of pneumatic or hydraulic pressure to the actuator becomes problematic. The current methods of overcoming the delivery of pressure from a stationary source to a rotating actuator is through a hydraulic/pneumatic union or isolation of the actuators force generating mechanisms: typically hydraulic/pneumatic cylinders.

The advantage of using hydraulic unions is that they are very compact, very efficient, and very powerful. Full hydraulic pressure can be redirected through these devices and delivered directly to the hex drive shaft either through racks and pinions or through linkages. In this mode of design, all the actuator's force generating components can be internalized within the actuator body. The internalizing of the force generating components (typically racks and pinions) allows the actuator to remain relatively small, in comparison to other styles of actuators, while still delivering comparable torque. As well, as all the force components are internalized, the possibility of damage is greatly reduced improving reliability. In addition, the union can be designed to operate as a plain bearing for the rotational component, eliminating the need for costly bearings and again saving space.

However, one draw back of the hydraulic union method is the design and use of small cross section hydrodynamic seals that seal oil glands between the stationary part of the actuator and the rotating part. The hydrodynamic seals provide positive sealing, due to seal compression, while the actuator remains stationary, but allow small amounts of oil to bypass when creating a dynamic seal. The bypassing oil ensures that the seal face remains lubricated, effectively creating a short journal bearing. The lubrication significantly reduces friction between the seal and the rotating member thereby extending seal life. Over time, this seepage and the combined inevitable seal wear from operation will escape to the environment, as collection and reuse methods are typically not incorporated into the actuator design.

The hydraulic fluid between the seal and the rotating member is subjected to high shear rates which in turn generate heat that is difficult to dissipate due to the actuators high thermal mass and small surface area. Further, if the hydraulic pressure to function the actuator acts on the seals while the actuator is rotating, the seals increase their facial surface force and act as a brake on the rotating member. Thus, heat generation and seal wear increase significantly.

In order to overcome leakage from the dynamic seals and the associated heat generation, some actuators have isolated the force generation by moving the hydraulic or pneumatic cylinders to the exterior non-rotating portion of the actuator. The external cylinders deliver a force to a moveable sleeve, isolated by bearings systems, which in turn drive linkages to create the torque at the actuator/DSSV stem interface.

The isolation of the cylinders often results in a larger less rigid actuator than the hydraulic union type due to the mounting methods of the cylinders and internal clearances required between the axially shifting base(s). The reduction in rigidity results in accelerated wear of the joints that connect the cylinders to the non-moving part. As well, any linkages that are used to supply torque to the interface between the actuator/DSSV often develop significant unintended clearances. The increased wear at joints of the linkages and cylinders leads to inaccurate functioning of the DSSV, i.e. the DSSV is not moved from full open to full close when the actuator is moved through its range of motion.

Linkages are typically not as efficient as rack and pinion designs, and do not possess the same amount of mechanical advantage. In addition, because of their low mechanical advantage, linkages can be susceptible to moving without being actuated, as the vibration associated with drilling has been known to cause these linkages to move under their own weight and inadvertently close the valve during drilling cycles.

Regardless of the actuator style, the output torque is often limited by the size of hydraulic or pneumatic cylinders that can be incorporated into the design and their respective radial offset location from the axis of the DSSV's crank center. In the case of the externally mounted cylinders, the cylinders usually have a small diameter with a thin wall in order to keep the overall actuator size to a minimum. The small thin walled cylinders have limited pressure retention; thus the output force is also limited. The union style actuators typically do not suffer from the same pressure limits to their force generation components. However, as the force generating components are internal to the small diameter bodies, the offset distance between the force generation and the crank center of rotation is severely limited.

For any DSSV, the correct alignment of the ball in the open and closed position is critical to optimal valve life. Without correct alignment in the open position, the leading edge of the ball and the trailing edge of the lower seat will be exposed to abrasive mud flow, causing premature wear and potentially vortices that can accelerate erosion. The resulting deflected flow path and resulting accelerated erosion can lead to premature failure.

As the alignment of the ball is critical for valve service life, most remote actuators rely on the valve's internal stops to set the alignment of the ball. Without the internal stops, most actuators would provide excess rotational motion thereby allowing the ball to over travel in both the open and close positions.

Since the DSSV stem internal stops are used, the stops often get damaged (resulting in misalignment of the ball) from the high contact stresses that the actuator's output torque generates. Very few actuators have a provision for adjusting the actuators output motion limits. This adjustment would allow the actuator to correct the balls alignment within the valve without the need to perform costly repairs on the valve itself.

It is, therefore, desirable to provide a DSSV that overcomes the shortcomings of the prior art by eliminating the need for a hydraulic union thus eliminating the leakage and seal wear problems that are associated with prior art designs.

### SUMMARY

An actuator for operating a DSSV on a drill stem that eliminates the need for a hydraulic union can be provided. In some embodiments, the actuator can comprise a mounting sleeve that can be affixed to a valve by a plurality of set screws and/or by a clamp at either end of the mounting sleeve. The mounting sleeve can comprise at least one pinion gear rotatably disposed on an outer sidewall of the mounting sleeve that can rotate a hex shaft of a hex drive. In some embodiments, the actuator can further comprise a rack sleeve slidably disposed circumferentially on the mounting sleeve, the rack sleeve comprising a rack disposed thereon, the rack configured to engage the at lest one pinion gear wherein sliding the rack sleeve linearly along the length of the mounting sleeve rotates the at least one pinion gear thus rotating the hex drive and a ball valve coupled thereto.

Broadly stated, in some embodiments, an actuator can be provided for operating a valve disposed in a rotatable drill stem comprising a passageway therein, the drill stem defining a longitudinal axis, the valve comprising a valve mechanism configured for opening and closing the passageway, the actuator comprising: a mounting sleeve configured for attaching to the valve, the mounting sleeve further comprising at least one pinion gear configured for coupling to the ball valve and rotating the ball valve to open and close the passageway; a rack sleeve circumferentially disposed on the mounting sleeve and configured for slidable movement up and down on the mounting sleeve along the longitudinal axis, the rack sleeve further comprising a rack configured to rotate the at least one pinion gear when the rack sleeve moves up and down on the mounting sleeve; and shifting means for slidably moving the rack sleeve on the mounting sleeve, the shifting means rotatably coupled to the mounting sleeve and to the rack sleeve wherein the shifting means is substantially stationary when the drill stem is rotating.

Broadly stated, in some embodiments, a method can be provided for operating a valve disposed in a rotatable drill stem comprising a passageway therein, the drill stem defining a longitudinal axis, the valve comprising a valve mechanism configured for opening and closing the passageway, the method comprising the steps of: providing an actuator, comprising: a mounting sleeve configured for attaching to the valve, the mounting sleeve further comprising at least one pinion gear configured for coupling to the ball valve and rotating the ball valve to open and close the passageway, a rack sleeve circumferentially disposed on the mounting sleeve and configured for slidable movement up and down on the mounting sleeve along the longitudinal axis, the rack sleeve further comprising a rack configured to rotate the at least one pinion gear when the rack sleeve moves up and down on the mounting sleeve, and shifting means for slidably moving the rack sleeve on the mounting sleeve, the shifting means rotatably coupled to the mounting sleeve and to the rack sleeve wherein the shifting means is substantially stationary when the drill stem is rotating; attaching the actuator to the valve; and moving the rack sleeve relative to the mounting sleeve using the shifting base to rotate the ball valve.

Broadly stated, in some embodiments, wherein the at least one pinion gear can further comprise a shaft that is configured to engage the ball valve.

Broadly stated, in some embodiments, the mounting sleeve can further comprise one or both of a threaded collar and a plurality of set screws configured to engage the valve to attach the mounting sleeve thereto.

Broadly stated, in some embodiments, the shifting means can comprise: first and second end plates rotatably attached to opposing ends of the mounting sleeve; at least one shroud plate operatively connecting the first and second end plates to form at least a partially enclosed or a fully enclosed structure; a shifting base disposed between the first and second end plates and circumferentially disposed on the rack sleeve, the rack sleeve and the shifting base, in combination, comprising means for enabling the shifting base to engage the rack sleeve and to rotate relative to the rack sleeve about the longitudinal axis; and the first and second end plates and the shifting base, in combination, comprising moving means for moving the shifting base linearly back and forth between the first and second end plates thereby engaging the rack sleeve to move slidably on the mounting sleeve along the longitudinal axis.

Broadly stated, in some embodiments, the moving means can comprise: a plurality of cylinder assemblies disposed between the first and second end plates and operatively coupled thereto, each of the plurality of cylinder assemblies comprising a cylinder housing slidable disposed on at least one piston rod, the cylinder housing operatively coupled to the shifting base, wherein the shifting base moves up and down between the first and second end plates as the cylinder housing moves along the at least one piston rod.

Broadly stated, in embodiments, wherein each of the plurality of cylinder assemblies can comprise a hydraulic piston and cylinder combination.

### BRIEF DESCRIPTION OF THE DRAWINGS

FIG. 1 is a perspective view depicting one embodiment of a drill stem safety valve actuator installed on a drill stem safety valve.

FIG. 2 is a perspective view depicting the actuator of FIG. 1.

FIG. 3 is a perspective view depicting the actuator of FIG. 2 with a portion of the shifting base removed to illustrate the rack and pinion mechanism.

FIG. 4 is an exploded perspective view depicting the actuator of FIG. 2.

FIG. 5 is an exploded perspective view depicting the mounting sleeve of the actuator of FIG. 4.

FIG. 6 is an exploded perspective view depicting an end plate of the actuator of FIG. 4.

FIG. 7 is a cutaway perspective view depicting a top end plate of the actuator of FIG. 2.

FIG. 8 is an exploded perspective view depicting the shifting base of the actuator of FIG. 4.

FIG. 9A is a side cross-section view depicting a hydraulic piston of the actuator of FIG. 4 in an open position.

FIG. 9B is a side cross-section view depicting the hydraulic piston of FIG. 9A in a closed position.

FIG. 10 is a perspective exploded view depicting a hydraulic piston of FIG. 9.

FIG. 11 is a perspective exploded view depicting the pinion gear of the actuator of FIG. 3.

FIG. 12 is a perspective cross-section view depicting the pinion gear of FIG. 11.

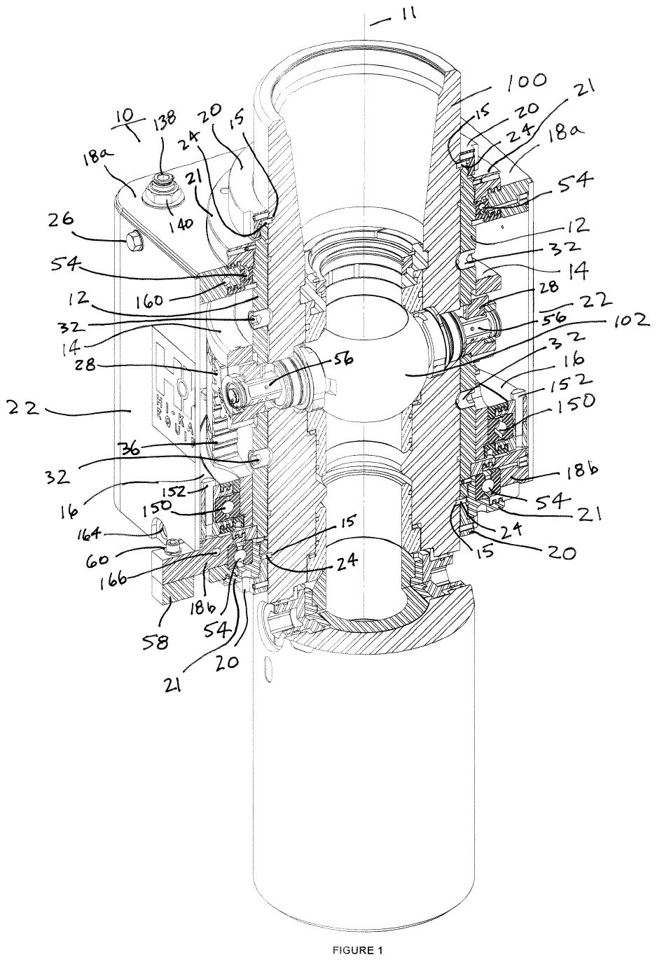

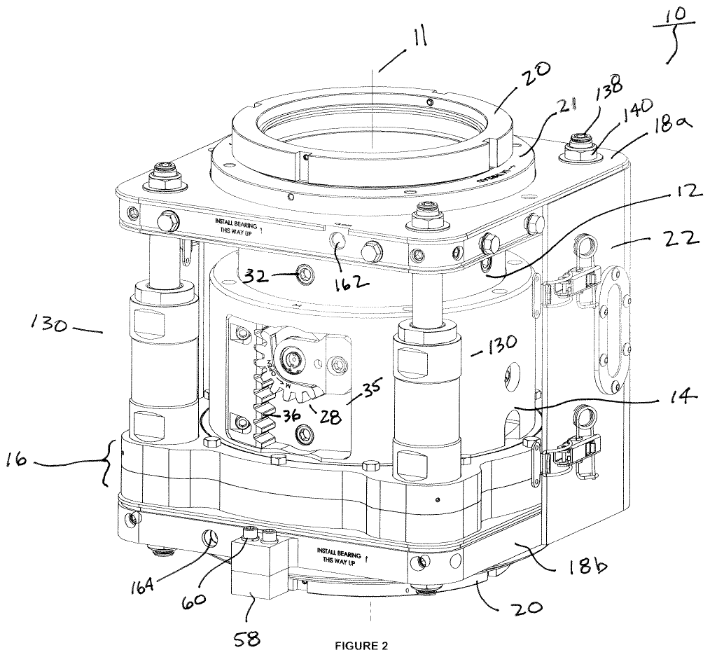

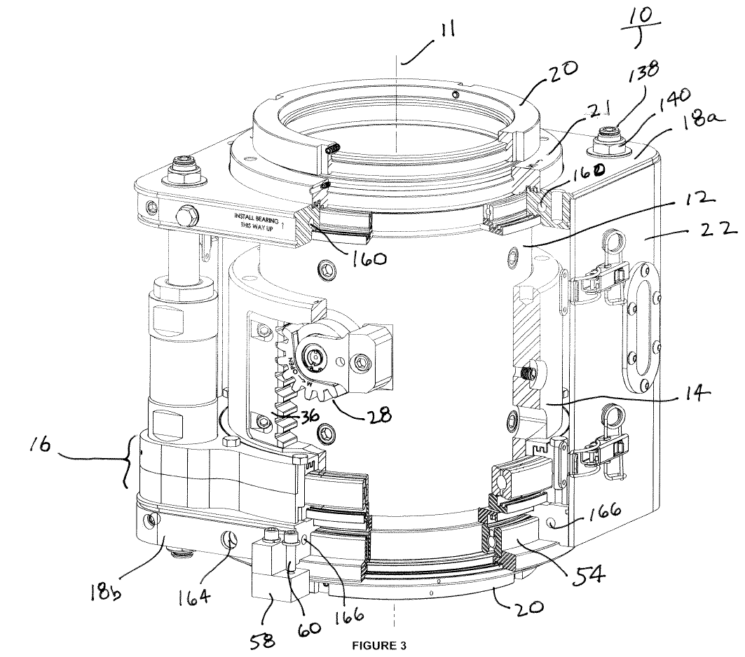

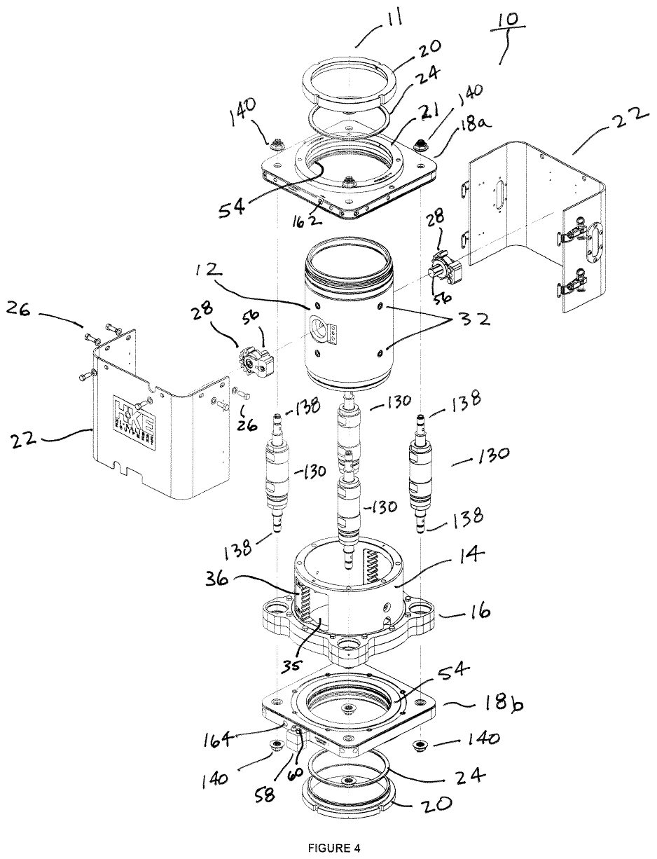

### DETAILED DESCRIPTION OF EMBODIMENTS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment can also be included in other embodiments but is not necessarily included. Thus, the present technology can include a variety of combinations and/or integrations of the embodiments described herein.

The presently disclosed subject matter is illustrated by specific but non-limiting examples throughout this description. The examples may include compilations of data that are representative of data gathered at various times during the course of development and experimentation related to the present invention(s). Each example is provided by way of explanation of the present disclosure and is not a limitation thereon. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

All references to singular characteristics or limitations of the present disclosure shall include the corresponding plural characteristic(s) or limitation(s) and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

While the following terms used herein are believed to be well understood by one of ordinary skill in the art, definitions are set forth to facilitate explanation of the presently disclosed subject matter.

Unless defined otherwise, all technical and scientific terms used herein have the same meaning as commonly understood by one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in this application, including the claims.

Unless otherwise indicated, all numbers expressing quantities, properties, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently disclosed subject matter.

As used herein, the term “about”, when referring to a value or to an amount of mass, weight, time, volume, concentration or percentage is meant to encompass variations of in some embodiments +/−50%, in some embodiments +/−40%, in some embodiments +/−30%, in some embodiments +/−20%, in some embodiments +/−10%, in some embodiments +/−5%, in some embodiments +/−1%, in some embodiments +/−0.5%, and in some embodiments +/−0.1% from the specified amount, as such variations are appropriate to perform the disclosed method.

Alternatively, the terms “about” or “approximately” can mean within an acceptable error range for the particular value as determined by one of ordinary skill in the art, which will depend in part on how the value is measured or determined, i.e., the limitations of the measurement system. For example, “about” can mean within 3, or more than 3, standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value. Unless otherwise indicated, all numbers expressing quantities, properties, and so forth used in the specification and claims are to be understood as being modified in all instances by the term “about”. And so, the numerical parameters set forth in this specification and claims are approximations that can vary depending upon the desired properties sought to be obtained by the presently disclosed subject matter.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Referring to the Figures, one embodiment of actuator 10 is shown. In some embodiments, actuator 10 can comprise, broadly, mounting sleeve 12, rack sleeve 14 and shifting base 16 disposed between spaced-apart and substantially parallel end plates 18a and 18b, wherein shroud plates 22 can be attached to end plates 18 with fasteners 26 to provide structural rigidity to actuator and to provide an enclosure for rack sleeve 14 and shifting base 16 disposed therein. Mounting sleeve 12 can define longitudinal axis 11 extending therethrough. Anchor block 58 can be attached to end plate 18b with cap screws 60 as a stop to prevent actuator 10 from rotating when the drill stem is rotating.

In some embodiments, actuator 10 can comprise bearings 54 disposed between end plates 18a and 18b and mounting sleeve 12 to enable the structure of end plates 18a and 18b, shroud plates 22, rack sleeve 14, and shifting base 16 disposed therein to remain stationary relative to mounting sleeve 12 as valve body 100 rotates as the drill stem rotates about longitudinal axis 11. In some embodiments, end plates 18a and 18b can be held in position with respect to mounting sleeve 12 by threaded collars 21 threadably attached thereto. To affix actuator 10 to valve body 100, spiral spring retainers 24 can be installed in grooves 15 disposed about valve body 100 that can then be held in place by threaded collars 20 threaded onto mounting sleeve 12. In some embodiments, actuator 10 can also comprise a plurality of set screws 32 threaded through mounting sleeve 12, set screws 32 fully configured to engage valve body 100.

In some embodiments, actuator 10 can comprise a plurality of cylinder assemblies 130 disposed between end plates 18a and 18b in a spaced-apart configuration about a circumference of actuator 10 to define a fixed structure for actuator 10 about valve body 100. In some embodiments, each cylinder assembly 130 can comprise ends 138 disposed through openings disposed through end plates 18a and 18b and secured thereto with fasteners 140. In the illustrated embodiment, actuator 10 comprises 4 of cylinder assemblies 130 disposed about the 4 corners of actuator 10 although a number of cylinder assemblies 130 can be less or more.

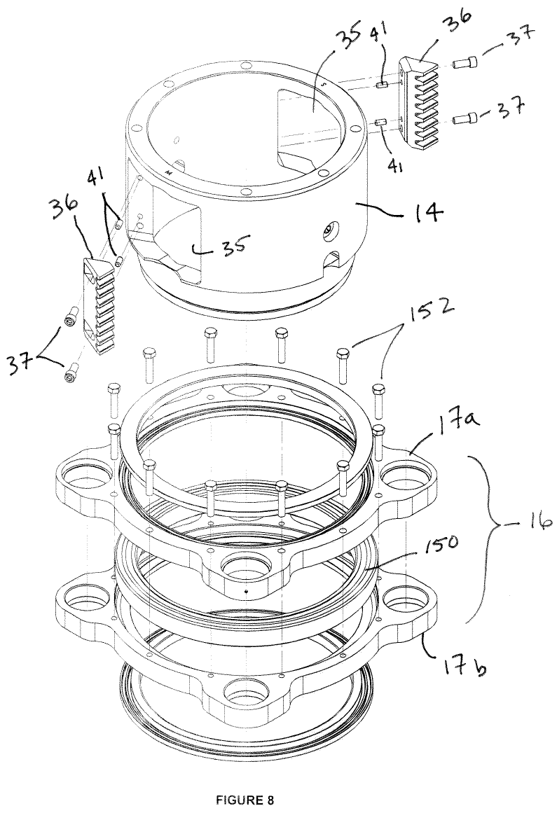

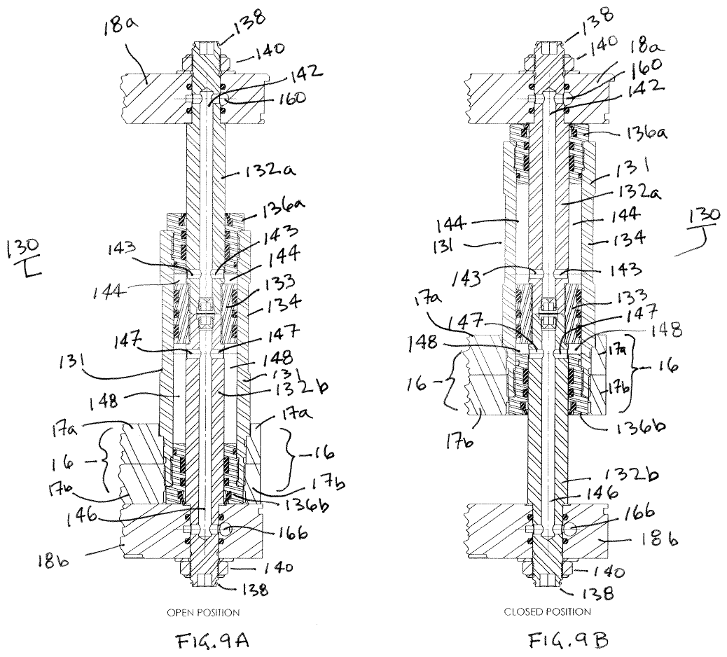

In some embodiments, actuator 10 can comprise shifting base 16 circumferentially disposed on rack sleeve 14. Referring to FIG. 8, one embodiment of shifting base 16 can comprise upper base 17a fastened to lower base 17b with a plurality of fasteners 152 whereby bearing 150 is disposed or “sandwiched” between upper and lower bases 17a and 17b. Referring to FIGS. 9A and 9B, a lower end of cylinder housing 131 can be operatively coupled shifting base 16 with end cap 136b passing through an opening in lower base 17b to operatively couple to cylinder housing 131 thus coupling shifting base 16 to cylinder housing 131 of cylinder assembly 130.

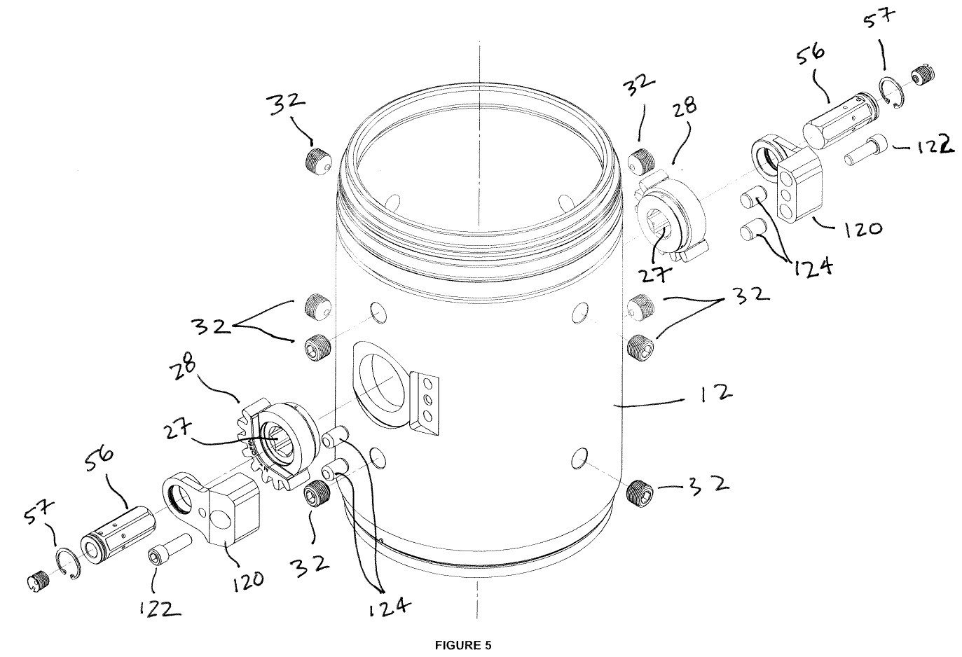

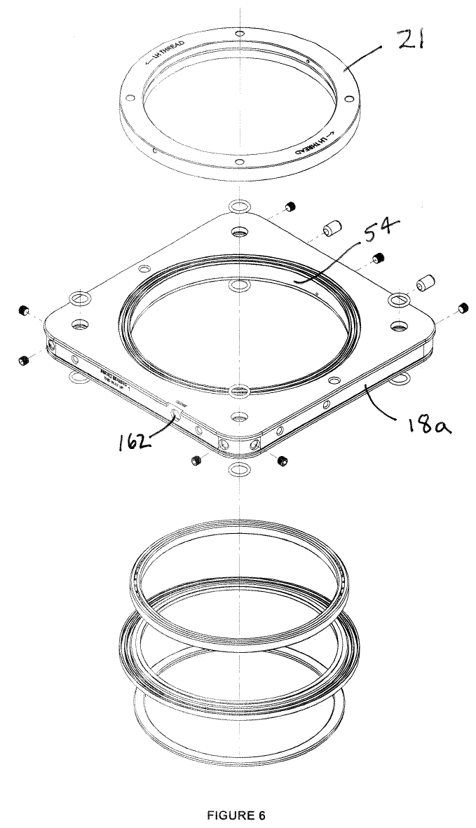

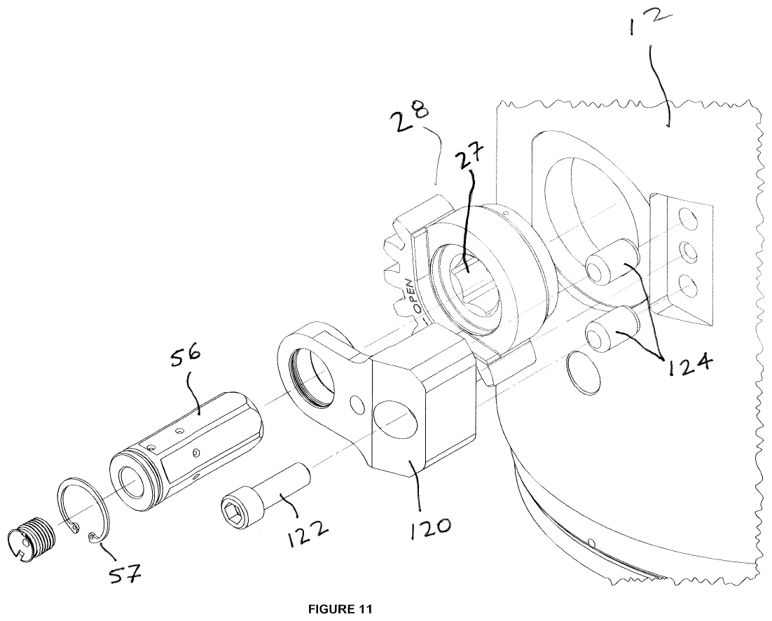

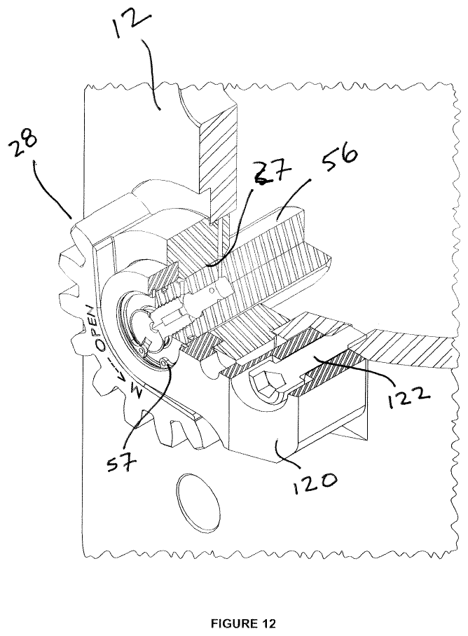

In some embodiments, mounting sleeve 12 can comprise one or more pinion gear 28 operatively coupled to hex drive 56 disposed through hex opening 27 disposed in pinion gear 28, as shown in FIG. 5. Thus, hex drive 56 can rotate ball valve 102 disposed in valve body 100 when pinion gear 28 is rotated. In some embodiments, pinion gear 28 can be kept in position by pinion support 120 that can be secured to mounting sleeve 12 by fasteners 120 and pins 122. In some embodiments, hex drive 56 can be retained within pinion gear 28 by circlip 57 disposed in pinion support 120. When rack sleeve 14 is circumferentially disposed on mounting sleeve 12, pinion gear 28 can be disposed in opening 35 to engage rack 36, thus, when rack sleeve 14 moves up and down along mounting sleeve 12, rack 36 can rotate pinion gear 28 to rotate ball valve 102 via hex drive 56. In some embodiments, rack 36 can be affixed to rack sleeve 14 with fasteners 37 and pins 41, as shown in FIGS. 8, 11, and 12.

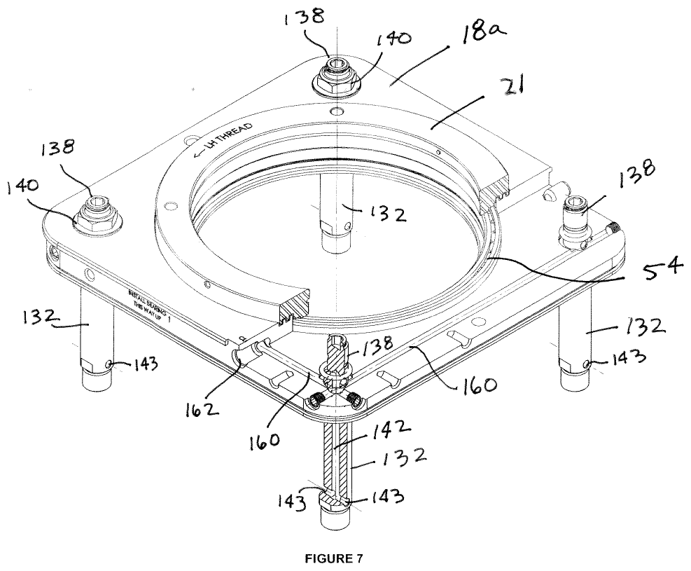

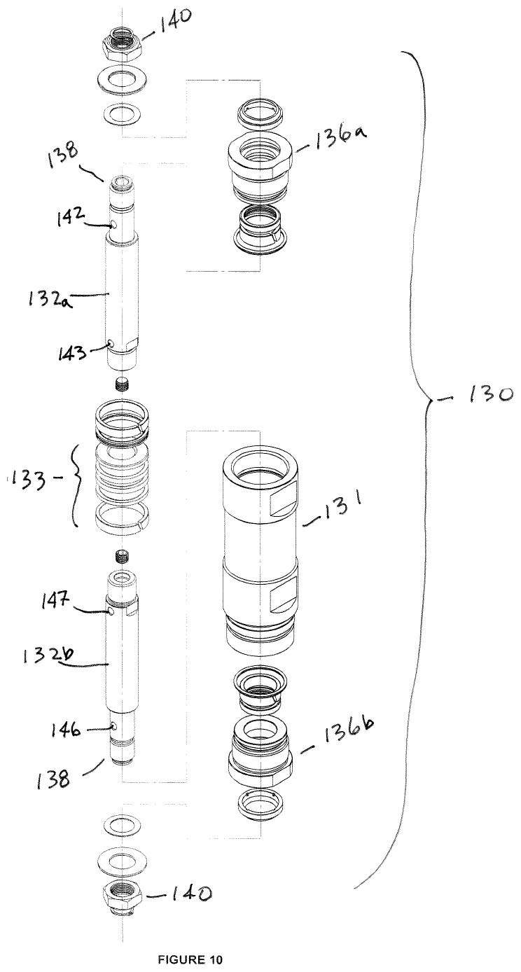

Referring to FIGS. 9A, 9B, and 10, one embodiment of cylinder assembly 130 is shown. In some embodiments, cylinder assembly 130 can comprise of upper and lower piston rods 132a and 132b coupled together with coupler 133. In some embodiments, cylinder housing 131 can be slidably disposed over the combination of coupler 133 and piston rods 132a and 132b. In some embodiments, piston rod 132a can comprise passageway 142 that can be in communication with passageway 160 disposed through end plate 18a that, in turn, can be in communication with opening 162. When hydraulic fluid is injected into opening 162, the fluid can flow through passageway 160 to each of cylinder assemblies 130 attached to end plate 18a (as shown in FIG. 7) where the fluid can pass through passageway 142 and then exit through orifice 143 of piston rod 132a into annulus 144 against end cap 136a to move cylinder housing 131 from a position where ball valve 102 is open (as shown in FIG. 9A) to a position where ball valve 102 is closed (as shown in FIG. 9B). Similarly, in some embodiments, piston rod 132b can comprise passageway 146 that can be in communication with passageway 166 disposed through end plate 18b that, in turn, can be in communication with opening 164, similar in configuration as end plate 18a as shown in FIG. 7. When hydraulic fluid is injected into opening 164, the fluid can flow through passageway 166 to each of cylinder assemblies 130 attached to end plate 18b where the fluid can pass through passageway 146 and then exit through orifice 147 of piston rod 132b into annulus 148 against end cap 136b to move cylinder housing 131 from a position where ball valve 102 is closed (as shown in FIG. 9B) to a position where ball valve 102 is open (as shown in FIG. 9A). Thus, when hydraulic fluid is injected into opening 162, shifting base 16 and, thus, rack sleeve 14, is raised relative to mounting sleeve 12 to close ball valve 102. Similarly, when hydraulic fluid is injected into opening 164, shifting base 16 and, thus, rack sleeve 14, is lowered relative to mounting sleeve 12 to open ball valve 102.

In some embodiments, as described above, cylinder assemblies 130 can be double acting hydraulic cylinders and when a plurality of cylinder assemblies 130 can be provided in a spaced-apart configuration disposed about a perimeter or circumference of actuator 10, the movement of the combination of shifting base 16 and rack sleeve 14 up and down mounting sleeve 12 can provide stable and reliable operation of closing and opening ball valve 102.

Although a few embodiments have been shown and described herein, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. An actuator for operating a valve disposed in a rotatable drill stem comprising a passageway therethrough, the drill stem defining a longitudinal axis, the valve comprising a ball valve disposed therein, the ball valve configured for opening and closing the passageway, the actuator comprising:
a) a mounting sleeve configured for attaching to the valve, the mounting sleeve further comprising at least one pinion gear configured for coupling to the ball valve and rotating the ball valve to open and close the passageway;
b) a rack sleeve circumferentially disposed on the mounting sleeve and configured for slidable movement up and down on the mounting sleeve along the longitudinal axis, the rack sleeve further comprising a rack configured to rotate the at least one pinion gear when the rack sleeve moves up and down on the mounting sleeve; and
c) shifting means for slidably moving the rack sleeve on the mounting sleeve, the shifting means rotatably coupled to the mounting sleeve and to the rack sleeve wherein the shifting means is substantially stationary when the drill stem is rotating.

2. The actuator as set forth in claim 1, wherein the at least one pinion gear comprises a shaft that is configured to engage the ball valve.

3. The actuator as set forth in claim 1, wherein the mounting sleeve further comprises one or both of a threaded collar and a plurality of set screws configured to engage the valve to attach the mounting sleeve thereto.

4. The actuator as set forth in claim 1, wherein the shifting means comprises:
a) first and second end plates rotatably attached to opposing ends of the mounting sleeve;
b) at least one shroud plate operatively connecting the first and second end plates to form at least a partially enclosed or a fully enclosed structure;
c) a shifting base disposed between the first and second end plates and circumferentially disposed on the rack sleeve, the rack sleeve and the shifting base, in combination, comprising means for enabling the shifting base to engage the rack sleeve and to rotate relative to the rack sleeve about the longitudinal axis; and
d) the first and second end plates and the shifting base, in combination, comprising moving means for moving the shifting base linearly back and forth between the first and second end plates thereby engaging the rack sleeve to move slidably on the mounting sleeve along the longitudinal axis.

5. The actuator as set forth in claim 4, wherein the moving means comprises a plurality of cylinder assemblies disposed between the first and second end plates and operatively coupled thereto, each of the plurality of cylinder assemblies comprising a cylinder housing slidable disposed on at least one piston rod, the cylinder housing operatively coupled to the shifting base, wherein the shifting base moves up and down between the first and second end plates as the cylinder housing moves along the at least one piston rod.

6. The actuator as set forth in claim 5, wherein each of the plurality of cylinder assemblies comprises a hydraulic piston and cylinder combination.

7. A method for operating a valve disposed in a rotatable drill stem comprising a passageway therethrough, the drill stem defining a longitudinal axis, the valve comprising a ball valve disposed therein, the ball valve configured for opening and closing the passageway, the method comprising the steps of:
a) providing an actuator, comprising:
i) a mounting sleeve configured for attaching to the valve, the mounting sleeve further comprising at least one pinion gear configured for coupling to the ball valve and rotating the ball valve to open and close the passageway,
ii) a rack sleeve circumferentially disposed on the mounting sleeve and configured for slidable movement up and down on the mounting sleeve along the longitudinal axis, the rack sleeve further comprising a rack configured to rotate the at least one pinion gear when the rack sleeve moves up and down on the mounting sleeve, and
iii) shifting means for slidably moving the rack sleeve on the mounting sleeve, the shifting means rotatably coupled to the mounting sleeve and to the rack sleeve wherein the shifting means is substantially stationary when the drill stem is rotating;
b) attaching the actuator to the valve; and
c) moving the rack sleeve relative to the mounting sleeve using the shifting base to rotate the ball valve.

8. The method as set forth in claim 7, wherein the at least one pinion gear comprises a shaft that is configured to engage the ball valve.

9. The method as set forth in claim 7, wherein the mounting sleeve further comprises one or both of a threaded collar and a plurality of set screws configured to engage the valve to attach the mounting sleeve thereto.

10. The method as set forth in claim 7, wherein the shifting means comprises:
a) first and second end plates rotatably attached to opposing ends of the mounting sleeve;
b) at least one shroud plate operatively connecting the first and second end plates to form at least a partially enclosed or a fully enclosed structure;
c) a shifting base disposed between the first and second end plates and circumferentially disposed on the rack sleeve, the rack sleeve and the shifting base, in combination, comprising means for enabling the shifting base to engage the rack sleeve and to rotate relative to the rack sleeve about the longitudinal axis; and
d) the first and second end plates and the shifting base, in combination, comprising moving means for moving the shifting base linearly back and forth between the first and second end plates thereby engaging the rack sleeve to move slidably on the mounting sleeve along the longitudinal axis.

11. The method as set forth in claim 10, wherein the moving means comprises a plurality of cylinder assemblies disposed between the first and second end plates and operatively coupled thereto, each of the plurality of cylinder assemblies comprising a cylinder housing slidable disposed on at least one piston rod, the cylinder housing operatively coupled to the shifting base, wherein the shifting base moves up and down between the first and second end plates as the cylinder housing moves along the at least one piston rod.

12. The method as set forth in claim 11, wherein each of the plurality of cylinder assemblies comprises a hydraulic piston and cylinder combination.
